(19) United States
(12) Patent Application Publication
(10) Pub. No.: US 2019/0075545 A1
(43) Pub. Date: Mar. 7, 2019

(54) METHOD AND APPARATUS FOR PROVIDING UNICAST REPRESENTATIONS WITHIN A BROADCAST COVERAGE AREA

(71) Applicant: QUALCOMM Incorporated, San Diego, CA (US)

(72) Inventors: Upendra Ram PRATURI, Hyderabad (IN); Ralph Akram GHOLMIEH, San Diego, CA (US); Carlos Marcelo Dias PAZOS, Carlsbad, CA (US)

(21) Appl. No.: 16/116,154

(22) Filed: Aug. 29, 2018

(30) Foreign Application Priority Data
Sep. 2, 2017 (IN) 201741031165

(51) Int. Cl. H04W 72/00; H04W 72/04; H04W 72/02

(52) U.S. Cl. CPC H04W 72/005; H04W 72/02; H04W 72/048

(57) ABSTRACT

An apparatus may be configured to receive a segment manifest and an indication of available content accessible through a MBMS service. In an aspect, the available content may include a first set of representations available in a broadcast coverage area, and a second set of representations and a third set of representations available in a unicast coverage area. The apparatus may be located within the broadcast coverage area and the unicast coverage area and elect to receive at least a component of the available content through the third set. Moreover, the apparatus may be further configured to receive at least the component of the available content through the third set of representations, via a unicast channel, based on which of the first set, the second set and the third set of representations are elected to be received.

### CROSS REFERENCES

The present application for patent claims priority to Indian Patent Application No. 201741031165 by Upendra Praturi et al. entitled “METHOD AND APPARATUS FOR PROVIDING UNICAST REPRESENTATIONS WITHIN A BROADCAST COVERAGE AREA,” filed Sep. 2, 2017 assigned to the assignee hereof.

### BACKGROUND

The present disclosure relates generally to communication systems, and more particularly, to providing Multimedia Broadcast Multicast Service (MBMS) service options.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. Another example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard.

In the context of content distribution through a MBMS service (e.g., eMBMS), a vendor may configure all video and audio representations to be available either via unicast for UEs not within a broadcast coverage area, or via broadcast for UEs within the broadcast coverage area.

As the demand for mobile broadband access continues to increase, there exists a need for further improvements, and additional flexibility with respect to content distribution options, in these to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

As noted above, infrastructure vendors may currently be limited to providing all video and audio representations either via unicast for UEs not within a broadcast coverage area, or via broadcast for UEs within the broadcast coverage area. But an infrastructure vendor may want to send some media over unicast instead of over broadcast (e.g., less popular secondary language option(s), less popular video angles, etc.). For example, if a UE is in broadcast coverage area, currently a UE (e.g., through a dynamic adaptive streaming over Hypertext Transfer Protocol (HTTP) (DASH) client) may only select representations available via broadcast. In other words, the current provisioning does not allow a UE (or a user) to choose from additional unicast representations while the UE is within the broadcast coverage area.

As discussed in more depth below, information noting available content may be modified to indicate that unicast representations are available to the UE while the UE is within the broadcast coverage area.

In an aspect of the disclosure, a method, a computer-readable medium, and an apparatus are provided. The apparatus may be configured to receive a segment manifest and an indication of available content accessible through a MBMS service. In an aspect, the available content may include a first set of representations available in a broadcast coverage area, and a second set of representations and a third set of representations available in a unicast coverage area. The apparatus may be located within the broadcast coverage area and the unicast coverage area. Moreover, the apparatus may be further configured to receive at least a component of the available content through the third set of representations, via a unicast channel, based on which of the first set, the second set and the third set of representations are elected to be received. In such an aspect, the second set of representations may be less preferred when the first set of representations is accessible, and the third set may be substantially equally preferred when the first set of representations is accessible.

A method of wireless communication is described. The method may include receiving, by a user equipment (UE), a segment manifest and an indication of available content accessible through a Multimedia Broadcast Multicast Service (MBMS), the available content being indicated through a first set of representations available in a broadcast coverage area, and a second set of representations and a third set of representations available in a unicast coverage area. The UE may be located within the broadcast coverage area and the unicast coverage area. The method may further include electing to receive at least a component of the available content through the third set, and receiving, via a unicast channel, at least the component of the available content through the third set of representations based on which of the first set, the second set and the third set of representations are elected to be received.

An apparatus for wireless communication is described. The apparatus may include means for receiving, by a user equipment (UE), a segment manifest and an indication of available content accessible through a Multimedia Broadcast Multicast Service (MBMS) service, the available content being indicated through a first set of representations available in a broadcast coverage area, and a second set of representations and a third set of representations available in a unicast coverage area. The UE may be located within the broadcast coverage area and the unicast coverage area. Further, the apparatus may include means for electing to receive at least a component of the available content through the third set. Moreover, the apparatus may include a receiver configured to receive, via a unicast channel, at least the component of the available content through the third set of representations based on which of the first set, the second set and the third set of representations are elected to be received.

A non-transitory computer readable medium storing code for wireless communication is described. The code may include instructions executable by a processor to receive, by a user equipment (UE), a segment manifest and an indication of available content accessible through a Multimedia Broadcast Multicast Service (MBMS) service, the available content being indicated through a first set of representations available in a broadcast coverage area, and a second set of representations and a third set of representations available in a unicast coverage area. The UE may be located within the broadcast coverage area and the unicast coverage area. The code may further include instructions executable by a processor to elect to receive at least a component of the available content through the third set, and receive, via a unicast channel, at least the component of the available content through the third set of representations based on which of the first set, the second set and the third set of representations are elected to be received.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating LTE examples of a DL frame structure, DL channels within the DL frame structure, an UL frame structure, and UL channels within the UL frame structure, respectively.

FIG. 3 is a diagram illustrating an example of an evolved Node B (eNB) and user equipment (UE) in an access network.

FIG. 4A is a diagram illustrating an example of Multicast Broadcast Single Frequency Network areas in an access network.

FIG. 4B is a diagram illustrating an example of an evolved Multimedia Broadcast Multicast Service channel configuration in a Multicast Broadcast Single Frequency Network.

FIG. 4C is a diagram illustrating a format of a Multicast Channel (MCH) Scheduling Information (MSI) Medium Access Control element.

FIG. 5 is a diagram of a communications system in which a MBMS service may be provided according to an aspect.

FIG. 6A is a diagram illustrating a conceptual data structure for indicating the availability of unicast content within a broadcast coverage area, according to an aspect.

FIG. 6B is another diagram illustrating a conceptual data structure for indicating the availability of unicast content within a broadcast coverage area, according to an aspect.

FIG. 7 is a flowchart of a method of wireless communication.

FIG. 8 is a conceptual data flow diagram illustrating the data flow between different means/components in an exemplary apparatus.

FIG. 9 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

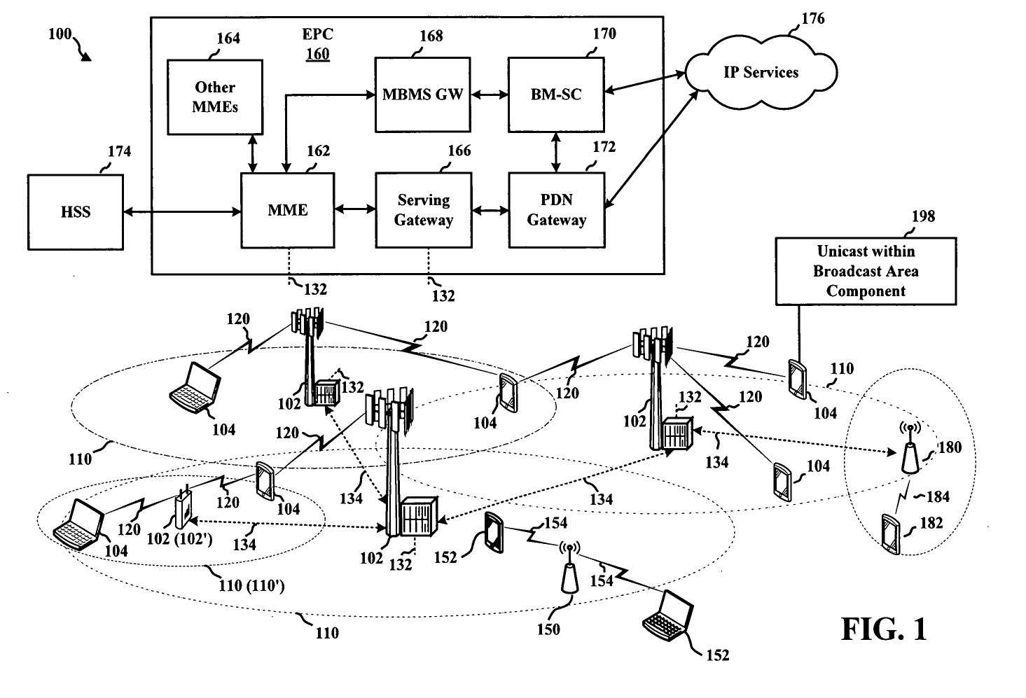

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include eNBs. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. The base stations 102/UEs 104 may use spectrum up to Y MHz (e.g., 5, 10, 15, 20 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ LTE and use the same 5 GHz unlicensed frequency spectrum as used by the Wi-Fi AP 150. The small cell 102′, employing LTE in an unlicensed frequency spectrum, may boost coverage to and/or increase capacity of the access network. LTE in an unlicensed spectrum may be referred to as LTE-unlicensed (LTE-U), licensed assisted access (LAA), or MuLTEfire.

The millimeter wave (mmW) base station 180 may operate in mmW frequencies and/or near mmW frequencies in communication with the UE 182. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 182 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include unicast within broadcast area component 198. In an aspect, unicast within broadcast area component 198 may be enabled through MBMS (e.g., eMBMS) middleware within UE 104. Further, unicast within broadcast area component 198 may be configured to receive a segment manifest and an indication of available content accessible through a MBMS service. In an aspect, the available content may include a first set of representations available in a broadcast coverage area, and a second set of representations and a third set of representations available in a unicast coverage area. Unicast within broadcast area component 198 may be configured to determine that the UE is located within the broadcast coverage area and the unicast coverage area. Moreover, unicast within broadcast area component 198 may be further configured to receive at least a component of the available content through the third set of representations based on which of the first set, the second set and the third set of representations are elected to be received. In such an aspect, the second set of representations may be less preferred when the first set of representations is accessible, and the third set may be substantially equally preferred when the first set of representations is accessible.

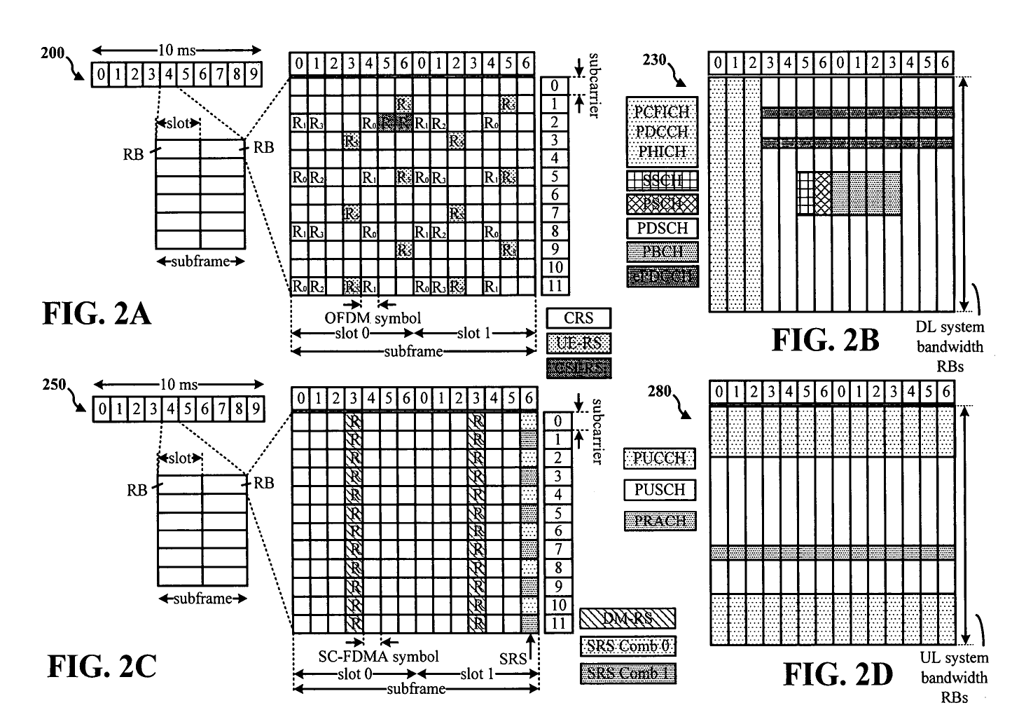

FIG. 2A is a diagram 200 illustrating an example of a DL frame structure in LTE. FIG. 2B is a diagram 230 illustrating an example of channels within the DL frame structure in LTE. FIG. 2C is a diagram 250 illustrating an example of an UL frame structure in LTE. FIG. 2D is a diagram 280 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

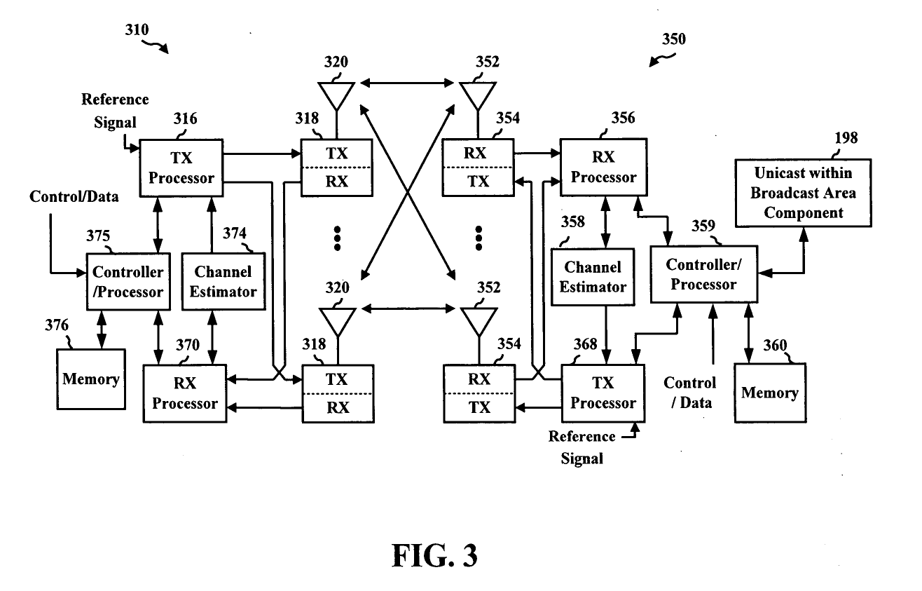

FIG. 3 is a block diagram of an eNB 310 in communication with a UE 350 in an access network. In the DL, 1P packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

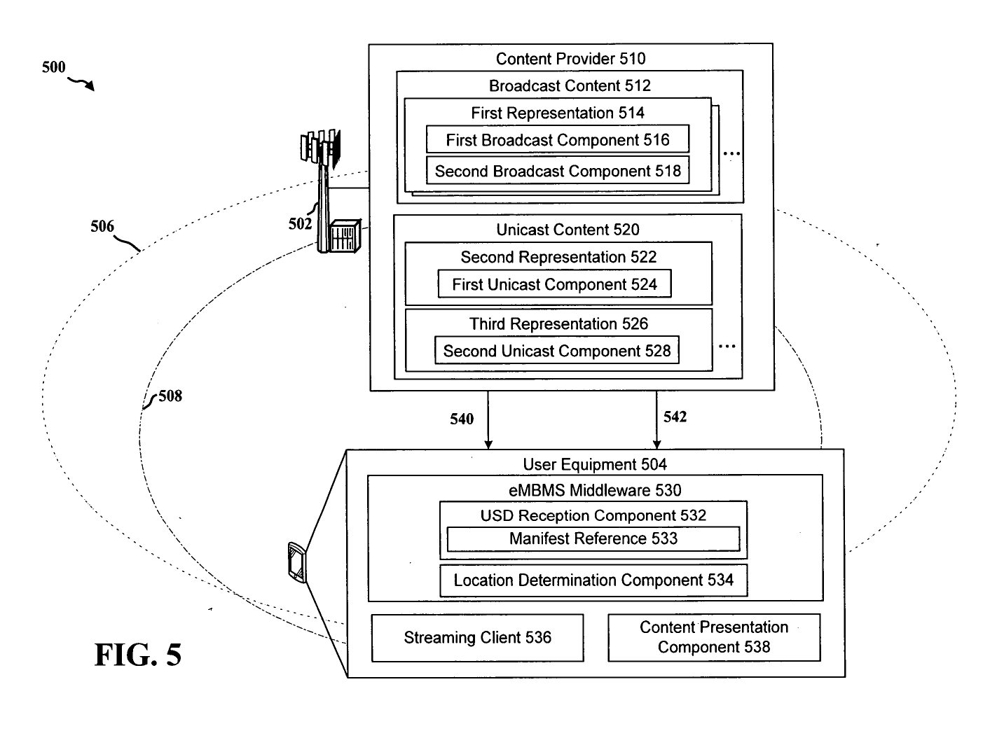

In an aspect, unicast within broadcast area component 198 may be enabled through functionality associated with controller/processor 359. For example, controller/processor 359 may enable unicast within broadcast area component 198 to determine a location of UE 350 and, based at least partly on the location information, determine MBMS service available to the UE. In such an aspect, the different components of the services available to the UE 350 may be provided via unicast and/or broadcast. For example, a video component of a service may be provided via broadcast while a secondary audio option may be provided via unicast. In another example, an audio component of the service may be provided via broadcast while a secondary video option (e.g., a different camera angle) may be provided via unicast. Further description of the unicast within broadcast area component 198 is provided in FIG. 5.

Similar to the functionality described in connection with the DL transmission by the eNB 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

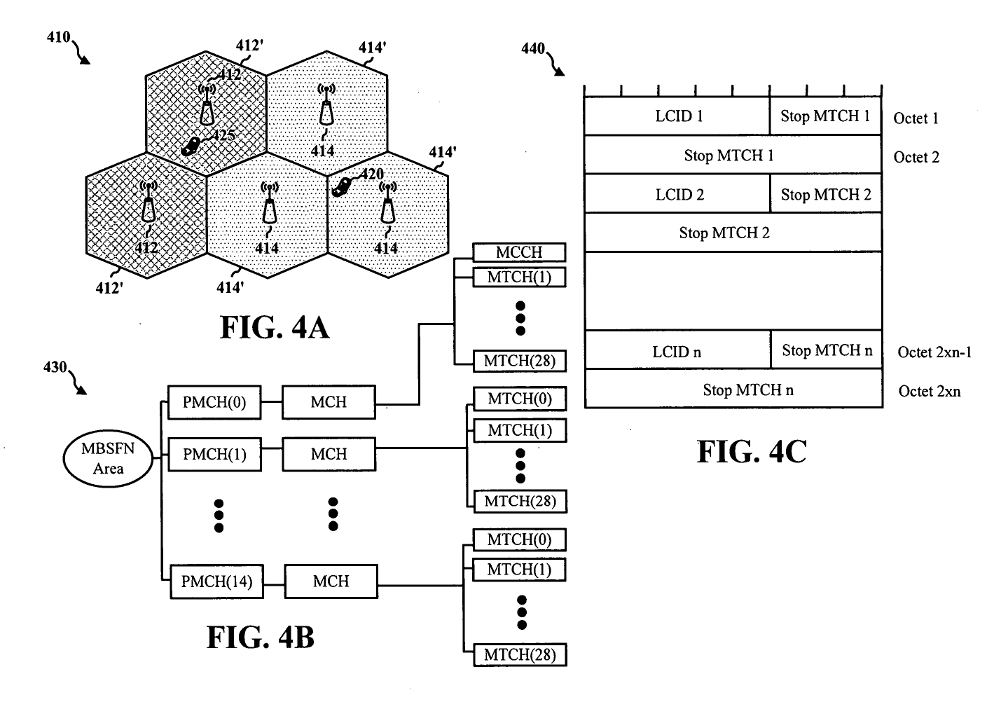

FIG. 4A is a diagram 410 illustrating an example of MBSFN areas in an access network. The eNBs 412 in cells 412′ may form a first MBSFN area and the eNBs 414 in cells 414′ may form a second MBSFN area. The eNBs 412, 414 may each be associated with other MBSFN areas, for example, up to a total of eight MBSFN areas. A cell within an MBSFN area may be designated a reserved cell. Reserved cells do not provide multicast/broadcast content, but are time-synchronized to the cells 412′, 414′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 4A, the first MBSFN area may support a first eMBMS broadcast service, such as by providing a particular news broadcast to UE 425. The second MBSFN area may support a second eMBMS broadcast service, such as by providing a different news broadcast to UE 420.

FIG. 4B is a diagram 430 illustrating an example of an eMBMS channel configuration in an MBSFN. As shown in FIG. 4B, each MBSFN area supports one or more physical multicast channels (PMCH) (e.g., 15 PMCHs). Each PMCH corresponds to an MCH. Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. Initially, the UE may acquire a SIB 13 (SIB13). Subsequently, based on the SIB13, the UE may acquire an MBSFN Area Configuration message on an MCCH. Subsequently, based on the MBSFN Area Configuration message, the UE may acquire an MSI MAC control element. The SIB13 may include (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted. A particular TMGI identifies a particular service of available MBMSs services.

FIG. 4C is a diagram 440 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area. A logical channel identifier (LCD) field (e.g., LCID 1, LCID 2, . . . , LCID n) may indicate a logical channel identifier of the MTCH. A Stop MTCH field (e.g., Stop MTCH 1, Stop MTCH 2, . . . , Stop MTCH n) may indicate the last subframe carrying the MTCH corresponding to the particular LCID. The size of the Stop MTCH field may span more than one octet (e.g., an 11 bit Stop MTCH 1 spans a portion of Octet 1 and all of Octet 2).

FIG. 5 is a diagram illustrating an example of a wireless communications system and an access network 500. The wireless communications system (also referred to as a wireless wide area network (WWAN)) includes base station(s) 502, UE(s) 504. In the depicted access network, a content provider 510 may make a MBMS (e.g., eMBMS) services (e.g., broadcast content 512 and unicast content 520) may be available within a broadcast coverage region 506 and/or a unicast coverage region 508.

In an aspect, broadcast content 512, available within the broadcast coverage region 506, may include multiple representations (e.g., first representation 514). As noted above, as used herein, multiple representations may also be referred to as a set of representations. Each representation may include components (e.g., different versions, different streaming quality options, multiple video angles, multiple audio options, subtitling, etc.) of an available service. In the depicted aspect, a first representation 514 of broadcast content 512 may include a first broadcast component 516 (e.g., a video component) and a second broadcast component 518 (e.g., an audio component). In an aspect, first broadcast component 516 and second broadcast component 518 may be multiplexed together in first representation 514; this is referred to as a multiplexed representation which may be used to reduce the number of objects used to describe the content or to ensure equal FEC protection for the components of the media stream. Although not expressly depicted in FIG. 5, one of ordinary skill in the art would appreciate that broadcast content 512 may include additional representations beyond first representation 514 and that each representation may include more, and/or combinations of, components beyond first broadcast component 516 and second broadcast component 518.

In an aspect, unicast content 520, available within unicast coverage region 508 may include multiple representations (e.g., different versions, different streaming quality options, multiple video angles, multiple audio options, subtitling, etc.). As noted above, as used herein, multiple representations may also be referred to as a set of representations. In the depicted aspect, unicast content 520 may include a second representation 522 which includes a first unicast component 524 (e.g., a video component). As noted above, each representation may include components (e.g., different versions, different streaming quality options, multiple video angles, multiple audio options, subtitling, etc.) of an available service. Unicast content 520 may also include a third representation 526 which includes a second unicast component 528 (e.g., a secondary audio component). For example, second broadcast component 518 may include English audio while second unicast component 528 may include a non-English audio option (e.g., Spanish, Hindi, Chinese, etc.). In another example, second broadcast component 518 may include a primary camera angle video feed while second unicast component 528 may include alternative camera angle video option(s). In an aspect, first unicast component 524 and second unicast component 528 may be communicated in a non-multiplexed manner. Although not expressly depicted in FIG. 5, one of ordinary skill in the art would appreciate that unicast content 520 may include additional representations beyond second representation 522 and third representation 526, and that each representation may include more, and/or combinations of, components beyond first unicast component 524 and second unicast component 528. In an aspect, content provider 510 may indicate options for accessing the MBMS through transmission of (e.g., broadcasting) a segment manifest 540 message (e.g., a DASH Media Presentation Description (MPD), or a HTTP live streaming (HLS) playlist). The segment manifest 540 file may include an indication of media segments in a URI template manner and a start index referencing a first segment of said media stream. For example, within a MPD, DASH may provide a streaming framework (e.g., for broadcast and unicast) where each DASH client may fetch Media Segments in sequence via HTTP. In another example, HLS may operate by breaking a media program down into a number of smaller HTTP-transmittable media files. A HLS playlist may be generated and provided to the media player before playback begins. The HLS playlist indicates the appropriate temporal sequence of the transmittable media files, and the address where they may be obtained. Segment manifest 540 may indicate that unicast representations (e.g., second representation 522, third representation 526, etc.) are available to UE 504 while the UE is within broadcast coverage region 506. Thereafter, content provider 510, through eNB 502 may provide the available content 542 within the broadcast coverage region 506 and the unicast coverage region 508. The available content 542 may be communicated using a MBMS bearer. Without any loss of generality, the options for accessing the content may be provided within the manifest, or within provisioning data provided separately from the manifest.

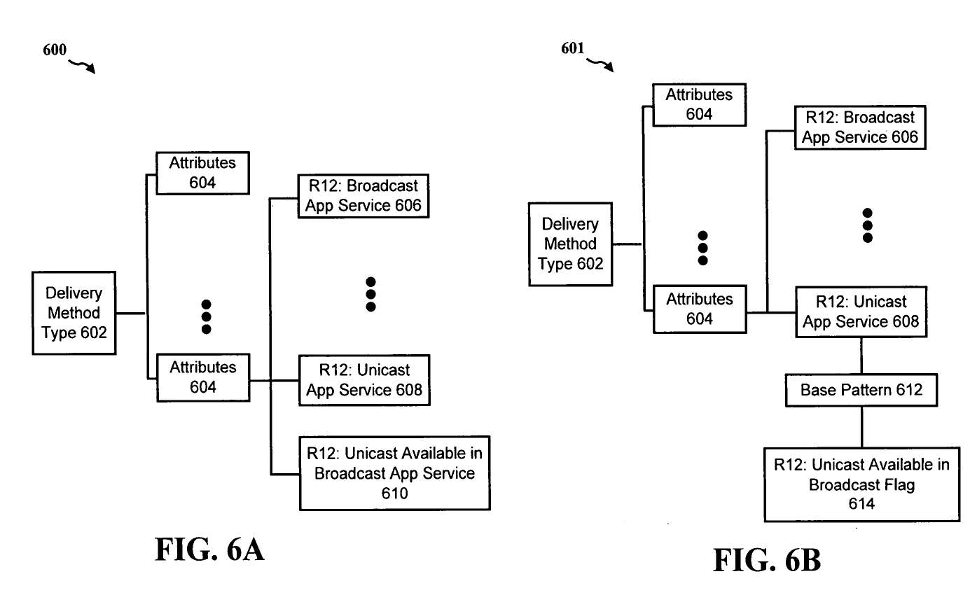

In access network 500, UE 504 may receive the segment manifest 540 and/or the available content 542. In an aspect, UE 504 may include eMBMS middleware 530 (e.g., unicast within broadcast area component 198) streaming client 536 and content presentation component 538. eMBMS middleware 530 may further include a User Service Description (USD) reception component 532 and location determination component 534. A USD may provide information related to a relationship between Service Area Identities (SAIs) and MBMS services. For example, the USD may include at least Temporary Mobile Group Identities (TMGIs) and MBMS SAIs as well as an association between the TMGIs and the MBMS SAIs. The USD may also include the segment manifest (e.g., DASH MPD, HLS playlist, etc.) which describes the service and may include a reference to the segment manifest 533 of the media associated with the service, and the availability of representations in broadcast or unicast. In possible implementations, the manifest and the USD of a service may be obtained as a bundle during a service discovery phase. When UE 504 is within the broadcast coverage area, as determined by location determination component 534, the segment manifest 540 and the associated access options may be processed by USD reception component 532 and indicate to eMBMS middleware 530 that one or more representations (e.g., second representation 522, third representation 526, etc.) via unicast are available along with the first representation 514 that is available via broadcast. In an aspect, eMBMS middleware 530 may receive segments over broadcast (e.g., available content 542 being communicated over a MBMS bearer) and make them available through a local HTTP server on the UE 504. Further detail associated with possible logical structures which may be used to indicate that the unicast content 520 is available within the broadcast coverage region 506 is provided in FIGS. 6A and 6B. An example logical structure may be to define a representation prefix (e.g., labeled as UnicastAvailablelnBroadcast). Another example logical structure option may be to set a flag within an existing defined representation (e.g., a flag within “r12:unicastAppService” as defined as part of the USD of service within 3GPP TS 26.346 release 12).

In operation, eMBMS middleware 503 may indicate content presentation options to streaming client 536. The eMBMS middleware may make this information available as part of a server and network assisted dynamic adaptive streaming over Hypertext Transfer Protocol (HTTP) (DASH) (SAND) message. In the SAND message, the middleware informs the streaming client 536 of what representation base patterns are currently available. Further discussion of base patterns is provided with respect to FIG. 6B.

Streaming client 536 may then elect which representation and/or component to indicate to content presentation component 538 for presentation on the UE. As used herein, content presentation component 538 may include physical components such as speakers, a display, etc., associated with UE 504. Election of which representation and component may be influenced by defined preferences. For example, the first unicast component (e.g., unicast video) may be comparatively less preferred when the first broadcast component (e.g., broadcast video) is accessible. As another example, second unicast component (e.g., secondary audio option) may be substantially equally preferred when second broadcast component (e.g., broadcast audio) is accessible. In such an example aspect, a user preference (e.g., user selection, UE 504 default setting, user history, etc.) may be used to determine that the second unicast component (e.g., secondary audio option) is preferred.

Further, in the operational aspect, based on the elections by streaming client 536, content presentation component 538 may present elected portions of the available content 542 on the UE 504 (e.g., displaying content on a display and playing the accompanying audio content through speakers associated with the UE 504).

FIG. 6A is a diagram illustrating a conceptual data structure 600 for indicating the availability of unicast content within a broadcast coverage area, according to an aspect. Each instance of broadcast maps to a unique representation delivered over the MBMS bearer. As noted above, the available content 542 may be communicated using the MBMS bearer. Further, each unique representation may include components (e.g., video and/or audio components). As noted above, the UE 504 may include eMBMS middleware 530 that may receive segments broadcast by the base station 502 (e.g., content provider) and provide them to a local HTTP server included in the UE 504. Furthermore, the eMBMS middleware may also receive information which may include the DASH client manifest file (e.g., manifest reference 533 of FIG. 5) and the USD that provides information on where DASH client representations are available (in broadcast/in unicast). The middleware may further tell an application service client, such as a DASH client (e.g., Streaming Client 536), about which representations are available for selection. The DASH client may remain agnostic of the transport mode (broadcast and/or unicast) of the representation to which the requested segment belongs. However, to inquire about which representations are preferred, the DASH client can request a SAND message from the server. The SAND message then includes which representations should be selected by the DASH client. In this invention, the additional signaling enables an eMBMS middleware to include unicast representations, as desired, when in broadcast coverage.

In an example aspect, an eMBMS service can be described by a delivery method type 602 directory which may include elements, such as attributes 604. A “broadcast app service” directory (e.g., 606, 608, 610) corresponding to respective components is set in the order below the attributes 604 (e.g., delivery method directory). This “broadcast app service” directory (e.g., 606, 608, 610) shows details of attributes/delivery mode 604 information concerning each of the components contained in the service. Attributes 604 may describe various manners in which the eMBMS service may be received. For example, an eMBMS service which includes unique representations that may include one or more components (e.g., video from a particular camera angle, audio in a particular language) may be received via a broadcast (e.g., R12: Broadcast App Service 606) or unicast (e.g., R12: Unicast App Service 608).

As described above, in some situations, it may be preferred to be able to receive a component of available content via broadcast (e.g., a primary video stream) while receiving another component of the available content via unicast (e.g., a secondary audio option). In such an aspect, a service descriptor, at the app service logical level, may be used to inform the UE of what different services are available (e.g., R12: Unicast Available in Broadcast App Service 610).

Additionally, or in the alternative, FIG. 6B depicts another data structure 601 for indicating the availability of unicast content within a broadcast coverage area, according to an aspect. In such an aspect, the indication of being able to receive a component of available content via broadcast (e.g., a primary video stream) while receiving another component of the available content via unicast (e.g., a secondary audio option) may be included as a flag within the unicast app service 608. For example, Unicast Available in Broadcast Flag 614 may be added to a base pattern 612 within the Unicast App Service 608 description. Base pattern 612 (e.g., access information (base pattern), transmission area information (service area), and transmission frequency information (radio frequency) of the respective components may be in the order below the “broadcast app service” directory 608 corresponding to the respective components.

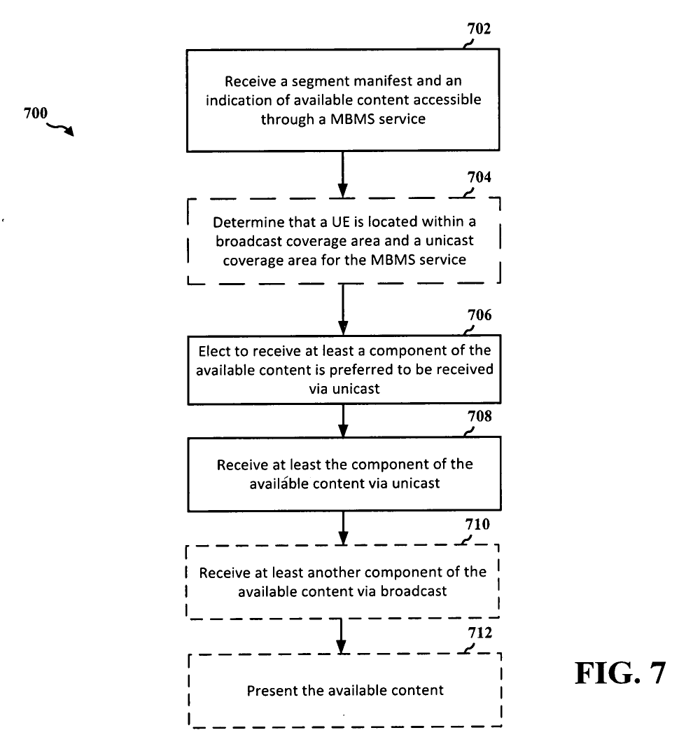

FIG. 7 is a flowchart 700 of an exemplary method of wireless communication. The method may be performed by a UE (e.g., UE 104, UE 504, the apparatus 802/802′). At 702, the UE may receive a segment manifest and an indication of available content accessible through a MBMS service. Without any loss of generality, the indication may be provided in a USD, in a SAND message, or in the manifest itself. In an aspect, the available content may be indicated through a first set of representations available in a broadcast coverage area. Further, in such an aspect, a second set of representations and/or a third set of representations may be available in a unicast coverage area. In an aspect, the second set and third set may be received as a union of the second set and third set along with a list of representations associated with the third set (e.g., FIG. 6A element 610). Additionally, or in the alternative, for such an aspect, the list of representation associated with the third set may be included in the union set, and a flag may be added to indicate which representations in the union set belong to the third set (e.g., FIG. 6B element 614). In an aspect, the segment manifest may be represented as a DASH Media Presentation Description (MPD) as part of a user service description (USD), a HTTP live streaming (HIS) playlist, etc. In operation, the UE reception of the segment manifest and the indication of available content may be enabled through an antenna and/or a receiver (e.g., antenna 352, receiver 354, RX processor 356, reception component 804, etc.).

In an optional aspect, at 704, the UE may determine that it is located within the broadcast coverage area and the unicast coverage area. Additionally, or in the alternative, the location of the UE may be predetermined to be within the broadcast coverage area and the unicast coverage area. Based on a determination and/or predetermined information, the eMBMS middleware within the UE may signal to a streaming client in the UE which of the representations are available. In other words, the eMBMS middleware may indicate which components of the content may be currently accessible based on the location. Alternatively, the streaming client may have access to the location information and the representation accessibility options as per some of the alternatives described previously. In this alternative, the DASH client can determine the availability of representation via broadcast and, concurrently, which components of the content may be accessible via unicast. In operation, the UE determination may be enabled through a processor and/or software/firmware/middleware associated with the processor (e.g., controller/processor 359, eMBMS Middleware 530, location determination component 534/806, unicast within broadcast component 810, streaming client 536/812, etc.).

At 706, the UE may elect to receive at receive at least a component of the available content via unicast. In other words, the UE/streaming client may elect to receive different components from different sources (e.g., video from broadcast and secondary audio from unicast, etc.). Election of which representation and component may be influenced by defined preferences. For example, the first unicast component (e.g., unicast video) may be comparatively less preferred when the first broadcast component (e.g., broadcast video) is accessible. As another example, second unicast component (e.g., secondary audio option) may be substantially equally preferred when second broadcast component (e.g., broadcast audio) is accessible. In such an example aspect, a user preference (e.g., user selection, UE 504 default setting, user history, etc.) may be used to determine that the second unicast component (e.g., secondary audio option) is preferred. In an aspect, when the UE has video components available via unicast and broadcast, the broadcast component may be preferred. In another aspect, when the UE has audio components available via unicast and broadcast, election of which component to choose may, as a default be substantially equally preferred. In such an aspect, user preferences may be used to select whether the UE elects to receive audio via broadcast or unicast. In operation, the UE determination may be enabled through a processor and/or software/firmware/middleware associated with the processor (e.g., controller/processor 359, eMBMS Middleware 530, location determination component 534/806, unicast within broadcast component 810, streaming client 536/812, etc.).

At 708, the UE may receive at least the component of the available content through the third set of representations based on which of the first set, the second set and the third set of representations are elected to be received. In other words, based on the UE location and available reception options, the UE may receive the secondary audio component via unicast even while present within the broadcast coverage area. In operation, the UE may receive the components of the content from one or more of the first, second, third, etc., sets through an antenna and/or a receiver (e.g., antenna 352, receiver 354, RX processor 356, reception component 804, etc.).

In an optional aspect, at 710, the UE may receive another component of the available content via broadcast. In an aspect, the broadcast video component may have been multiplexed with a broadcast audio component. In such an aspect, the UE may receive multiplexed component via broadcast, demultiplex the video and audio and disregard the audio component (as the UE is receiving a secondary/preferred audio component via unicast).

Additionally, in an optional aspect, at 712, the UE may present the content. In an aspect, the UE presents the content by displaying the video component of the content on a display and playing the accompanying audio component through speakers associated with the UE.

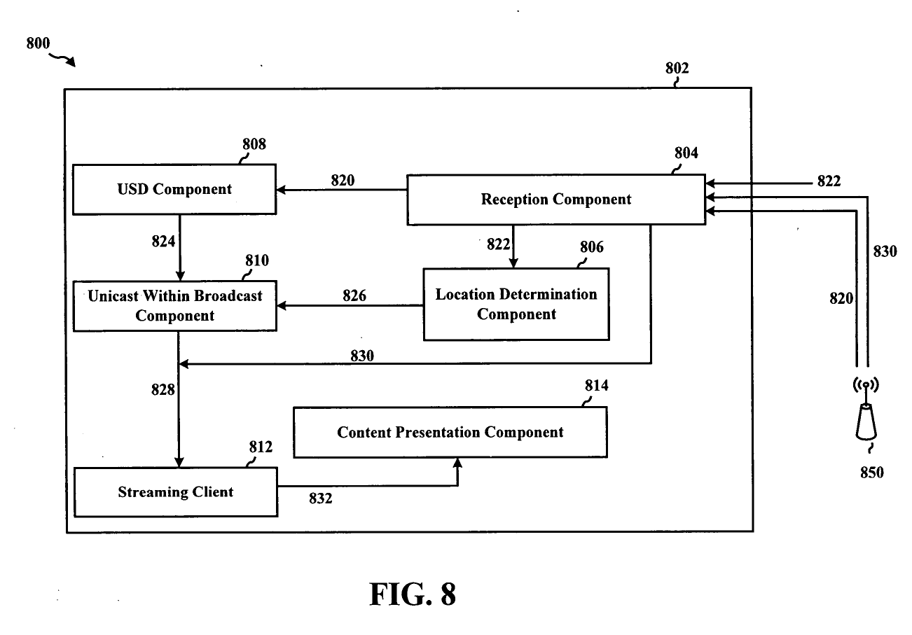

FIG. 8 is a conceptual data flow diagram 800 illustrating the data flow between different means/components in an exemplary apparatus 802. The apparatus may be a UE. The apparatus includes a reception component 804 that receives a segment manifest 820 and an indication of available content 830 accessible through a MBMS service. In an aspect, reception component 804 may also receive location information 822 (e.g., global positioning service (GPS) information). Location determination component 806 may use location information 822 to determine the location of the apparatus 802. USD component 808 may use segment manifest 820 information received from reception component to determine representations 824 of content 830 that is available from a content provider via eNB 850. Unicast within broadcast component 810 may use the information associated with which representations 824 of the content 830, along with an indication 826 that UE is located within both broadcast and unicast coverage areas, to determine which representations and/or which components within each representation 828 may be preferred. Streaming client 812 may use the information associated with available/preferred representations 828, and the content 830 received from reception model to elect to present the elected content 832, in which a component is received via broadcast and another component is received via unicast. Content presentation component 814 may present the elected content 832 on the apparatus 802. For example, content presentation component 814 presents the content by displaying the video component of the content 832 on a display (not shown) and playing the accompanying audio component through speakers (not shown associated with the apparatus 802/

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

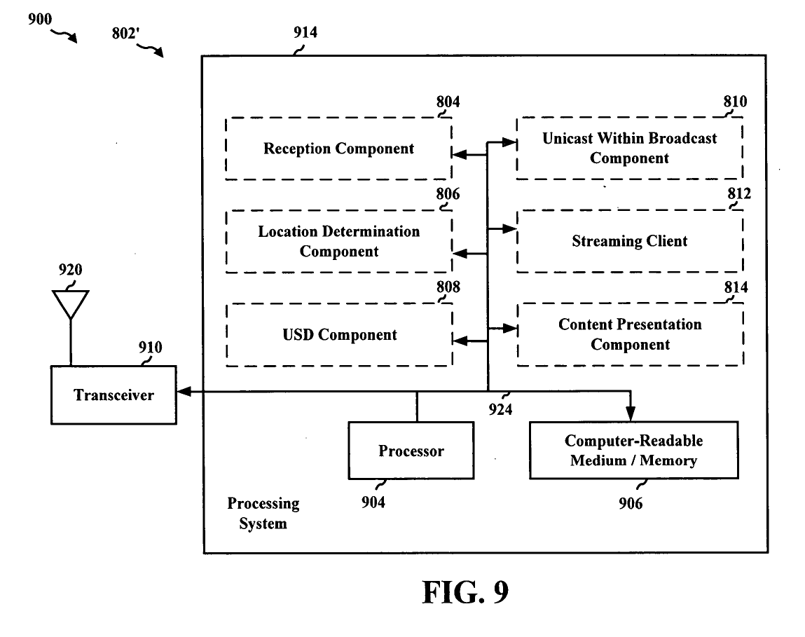

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, 814 and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810, 812, and 814. The components may be software components running in the processor 904, resident/stored in the computer readable medium/memory 906, one or more hardware components coupled to the processor 904, or some combination thereof. The processing system 914 may be a component of the UE 350 and may include the memory 360 and/or at least one of the TX processor 368, the RX processor 356, and the controller/processor 359.

In one configuration, the apparatus 802/802′ for wireless communication includes means for receiving a segment manifest and an indication of available content accessible through a MBMS service, means for determining that the UE is located within the broadcast coverage area and the unicast coverage area, and means for receiving at least a component of the available content via a unicast channel. In an aspect, the means for receiving via the unicast channel may be further configured to receive via a broadcast channel. In an aspect, the means for determining may be further configured to signal, to a streaming client, which set of representations are available for selection, receive the signaling, and elect, by the streaming client, to receive the at least a component of the available content through the third set via the unicast channel. Additionally, on in the alternative, in an aspect, apparatus 802/802′ may further include means for presenting the received content. The aforementioned means may be one or more of the aforementioned components of the apparatus 802 and/or the processing system 914 of the apparatus 802′ configured to perform the functions recited by the aforementioned means. As described supra, the processing system 914 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communications, comprising:
receiving, by a user equipment (UE), a segment manifest and an indication of available content accessible through a Multimedia Broadcast Multicast Service (MBMS), the available content being indicated through a first set of representations available in a broadcast coverage area, and a second set of representations and a third set of representations available in a unicast coverage area, wherein the UE is located within the broadcast coverage area and the unicast coverage area;
electing to receive at least a component of the available content through the third set; and
receiving, via a unicast channel, at least the component of the available content through the third set of representations based on which of the first set, the second set and the third set of representations are elected to be received.

2. The method of claim 1, wherein the second set of representations is less preferred when the first set of representations is accessible, and wherein the third set is substantially equally preferred when the first set of representations is accessible.

3. The method of claim 2, wherein at least a portion of the election is performed by an eMBMS middleware on the UE.

4. The method of claim 3, wherein the electing further comprises:
signaling, to a streaming client in the UE, which of the first set, the second set and the third set of representations are available for selection based on the election; and
receiving, by the streaming client, the signaling.

5. The method of claim 1, wherein the second set and third set are received as a union of the second set and third set along with a list of representations associated with the third set.

6. The method of claim 1, further comprising presenting the available content on the UE.

7. The method of claim 1, further comprising receiving, via a broadcast channel, another component of the available content through the first set of representations.

8. The method of claim 7, wherein the another component of the available content accessible through the first set comprises a video component, and wherein the component of the available content accessible through the third set comprises an audio component.

9. The method of claim 8, wherein the audio component comprises a secondary audio option, and wherein the first set of representations includes a primary audio option.

10. An apparatus for wireless communication, comprising:
means for receiving, by a user equipment (UE), a segment manifest and an indication of available content accessible through a Multimedia Broadcast Multicast Service (MBMS) service, the available content being indicated through a first set of representations available in a broadcast coverage area, and a second set of representations and a third set of representations available in a unicast coverage area, wherein the UE is located within the broadcast coverage area and the unicast coverage area;
means for electing to receive at least a component of the available content through the third set; and
a receiver configured to receive, via a unicast channel, at least the component of the available content through the third set of representations based on which of the first set, the second set and the third set of representations are elected to be received.

11. The apparatus of claim 10, wherein the second set of representations is less preferred when the first set of representations is accessible, and wherein the third set is substantially equally preferred when the first set of representations is accessible.

12. The apparatus of claim 11, wherein at least a portion of the election is performed by an eMBMS middleware on the UE.

13. The apparatus of claim 12, wherein the means for electing further comprises:
means for signaling, to a streaming client in the UE, which of the first set, the second set and the third set of representations are available for selection based on the election; and
means for receiving, by the streaming client, the signaling.

14. The apparatus of claim 10, wherein the receiver is further configured to receive, via a broadcast channel, another component of the available content through the first set of representations.

15. The apparatus of claim 14, wherein the another component of the available content accessible through the first set comprises a video component, and wherein the component of the available content accessible through the third set comprises an audio component.

16. The apparatus of claim 15, wherein the audio component comprises a secondary audio option, and wherein the first set of representations includes a primary audio option.

17. An apparatus for wireless communication, comprising:
a memory; and
a receiver configured to:
receive a segment manifest and an indication of available content accessible through a Multimedia Broadcast Multicast Service (MBMS) service, the available content being indicated through a first set of representations available in a broadcast coverage area, and a second set of representations and a third set of representations available in a unicast coverage area, wherein the apparatus is located within the broadcast coverage area and the unicast coverage area; and
at least one processor coupled to receiver and the memory and configured to:
elect to receive at least a component of the available content through the third set;
wherein the receiver is further configured to:
receive, via a unicast channel, at least the component of the available content through the third set of representations based on which of the first set, the second set and the third set of representations are elected to be received.

18. The apparatus of claim 17, wherein the second set of representations is less preferred when the first set of representations is accessible, and wherein the third set is substantially equally preferred when the first set of representations is accessible.

19. The apparatus of claim 18, wherein the apparatus is a user equipment (UE), and wherein at least a portion of the election is performed by an eMBMS middleware on the UE.

20. The apparatus of claim 19, wherein the at least one processor is further configured to:
signal, to a streaming client in the UE, which of the first set, the second set and the third set of representations are available for selection based on the election; and
receive, by the streaming client, the signaling.

21. The apparatus of claim 17, wherein the second set and third set are received as a union of the second set and third set along with a list of representations associated with the third set.

22. The apparatus of claim 17, wherein the apparatus comprises a display screen and wherein the at least one processor is further configured to present the available content on the display screen.

23. The apparatus of claim 17, wherein the receiver is further configured to receive, via a broadcast channel, another component of the available content through the first set of representations.

24. The apparatus of claim 21, wherein the another component of the available content accessible through the first set comprises a video component, and wherein the component of the available content accessible through the third set comprises an audio component.

25. The apparatus of claim 24, wherein the audio component comprises a secondary audio option, and wherein the first set of representations includes a primary audio option.

26. A computer-readable medium storing computer executable code, comprising code to:
receive, by a user equipment (UE), a segment manifest and an indication of available content accessible through a Multimedia Broadcast Multicast Service (MBMS) service, the available content being indicated through a first set of representations available in a broadcast coverage area, and a second set of representations and a third set of representations available in a unicast coverage area, wherein the UE is located within the broadcast coverage area and the unicast coverage area;
elect to receive at least a component of the available content through the third set; and
receive, via a unicast channel, at least the component of the available content through the third set of representations based on which of the first set, the second set and the third set of representations are elected to be received.

27. The computer-readable medium of claim 26, wherein the second set of representations is less preferred when the first set of representations is accessible, and wherein the third set is substantially equally preferred when the first set of representations is accessible.

28. The computer-readable medium of claim 27, wherein at least a portion of the election is performed by an eMBMS middleware on the UE.

29. The computer-readable medium of claim 28, wherein the computer executable code is further configured to:
signal, to a streaming client in the UE, which of the first set, the second set and the third set of representations are available for selection based on the election; and
receive, by the streaming client, the signaling.

30. The computer-readable medium of claim 26, wherein the computer executable code is further configured to:
receive, via a broadcast channel, another component of the available content through the first set of representations, wherein the another component of the available content accessible through the first set comprises a video component, and wherein the component of the available content accessible through the third set comprises an audio component.
